(19) United States
(12) Patent Application Publication
(10) Pub. No.: US 2018/0010212 A1
(43) Pub. Date: Jan. 11, 2018

(54) COPPER-ZINC ALLOY AND USE THEREOF

(71) Applicant: DIEHL METALL STIFTUNG & CO. KG, ROETHENBACH (DE)

(72) Inventor: NORBERT GAAG, LAUF (DE)

(21) Appl. No.: 15/713,932

(22) Filed: Sep. 25, 2017

Related U.S. Application Data
(63) Continuation of application No. PCT/EP2016/000404, filed on Mar. 8, 2016.

(30) Foreign Application Priority Data
Mar. 24, 2015 (DE) 102015003687.4

(51) Int. Cl. C22C 9/04; F16C 33/12

(52) U.S. Cl. CPC C22C 9/04; F16C 33/12

(57) ABSTRACT

A copper-zinc alloy contains 59.0 to 65.0% Cu, 2.5 to 4.0% Mn, 1.2 to 2.5% Al, 0.5 to 2.0% Si, 0.2 to 1.0% Fe, 0 to 1.0% Pb, 0 to 1.5% Ni, 0 to 0.2% Sn, balance Zn and unavoidable impurities. The zinc alloy has excellent temperature resistance and surfaces produced by machining have a considerably reduced surface roughness.

### CROSS-REFERENCE TO RELATED APPLICATION

This application is a continuation, under 35 U.S.C. §120, of copending international application No. PCT/EP2016/000404, filed Mar. 8, 2016, which designated the United States; this application also claims the priority, under 35 U.S.C. §119, of German patent application No. DE 10 2015 003 687.4, filed Mar. 24, 2015; the prior applications are herewith incorporated by reference in their entirety.

### BACKGROUND OF THE INVENTION

### Field of the Invention

The invention relates to a copper-zinc alloy and to a use of such an alloy.

Published, non-prosecuted German patent application DE 10 2007 063 643 A1 (corresponding to U.S. patent publication No. 2009/0022620) discloses a copper-zinc alloy, which is characterized by a high resistance to abrasive wear.

Published, non-prosecuted German patent application DE 10 2005 015 467 A1 (corresponding to U.S. patent publication No. 2013/0078137) discloses a further copper-zinc alloy for use as a material for a plain bearing. The alloy has good temperature and wear resistance.

In practice, it has been found that for producing bearing bushings for turbochargers in particular the abovementioned copper-zinc alloys are of only limited usefulness. Such bearing bushings must be manufactured with a tolerance of just a few μm. Such a tolerance cannot always be maintained with conventional copper-zinc alloys because the surface roughness of machined surfaces is sometimes too great.

### SUMMARY OF THE INVENTION

The invention has for its object to eliminate the disadvantages of the prior art. Specifically, a copper-zinc alloy is to be provided which allows manufacture of bearing bushings with reduced surface roughness.

According to an aspect of the invention, a copper-zinc alloy is proposed containing 59.0 to 65.0% Cu, 2.5 to 4.0% Mn, 1.2 to 2.5% Al, 0.5 to 2.0% Si, 0.2 to 1.0% Fe, 0 to 1.0% Pb, 0 to 1.5% Ni, 0 to 0.2% Sn, balance Zn and unavoidable impurities.

All values in “%” refer to “weight percent”.

The proposed copper-zinc alloy has excellent temperature resistance. Surfaces produced by machining have a considerably reduced surface roughness. The proposed copper-zinc alloy is particularly suitable for producing bearing bushings, in particular bearing bushings for turbochargers. The copper-zinc alloy may be processed by extrusion, drawing, casting and cold and hot forming, for example extrusion, drawing and stress-relief annealing.

The copper-zinc alloy may contain 62.5 to 64.5% Cu, 2.7 to 3.5% Mn, 1.3 to 1.9% Al, 0.8 to 1.2% Si, 0.3 to 0.6% Fe, 0 to 1.0% Pb, 0 to 1.5% Ni, 0 to 0.2% Sn, balance Zn and unavoidable impurities, in particular the copper-zinc alloy may comprise 63.0 to 64.0% Cu, 2.9 to 3.2% Mn, 1.4 to 1.9% Al, 0.8 to 1.2% Si, 0.3 to 0.6% Fe, 0 to 1.0% Pb, 0.5 to 0.7% Ni, 0 to 0.2% Sn, balance Zn and unavoidable impurities.

In a particularly preferred embodiment, the alloying constituent Pb and/or Sn is eschewed.

The copper-zinc alloy according to the invention has an electrical conductivity of preferably more than 9.0 m/ohm mm². The electrical conductivity correlates with the thermal conductivity. The proposed alloy features a particularly high thermal conductivity of more than 60 W/mK at room temperature.

Furthermore, it is advantageously a feature of the proposed copper-zinc alloy that in the cast state intermetallic compounds present in the microstructure have a size of not more than 150 μm. The small size of the intermetallic compounds advantageously contributes to the feature that machining can produce a surface with a reduced surface roughness. According to a further aspect of the invention, the proposed copper-zinc alloy is used for producing a bearing bushing for a plain bearing, in particular a turbocharger bearing bushing.

An example of the proposed copper-zinc alloy is more particularly elucidated hereinbelow.

The copper-zinc alloy may have the following composition:

### Cu 64.2%

### Mn 2.0%

### Al 1.8%

### Si 1.3%

### Fe 0.8%

### Ni 0.8%

Zn balance

Mechanical properties of the copper-zinc alloy are apparent from the following table.

TABLE 1

| | | | Hardness |
|---|---|---|---|
| Rₘ (N/mm²) | R_{p0.2} (N/mm²) | A (%) | (HBW 2.5/62.5) |
| 515 | 286 | 25 | 167 |

The copper-zinc alloy has the physical properties shown in the table below.

TABLE 2

| Property | |
|---|---|
| Density g/cm³ | 8.1 |
| Electrical conductivity m/ohm mm² | 9.3 |
| Modulus of elasticity kN/mm² | 131 |
| Coefficient of longitudinal thermal | 15.7 |
| expansion | |
| Poisson's ratio | 0.39 |

The hot tensile strength of the copper-zinc alloy is about 321 N/mm² at 350° C. The copper-zinc alloy features an excellent softening behavior. To determine softening behavior the alloy was subjected for an annealing time of 1 hour to temperatures of up to 500° C. It was found that up to a temperature of 500° C. no reduction in hardness is observed compared to hardness at room temperature. Even for a thermal treatment of 600° C. the drop in hardness is less than 10% of the initial hardness at room temperature.

Other features which are considered as characteristic for the invention are set forth in the appended claims.

Although the invention is illustrated and described herein as embodied in a copper-zinc alloy and use thereof, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration showing a microstructure of a copper-zinc alloy according to the invention;

FIG. 2 is a cross-sectional view of a machined surface of the copper-zinc alloy; and

FIG. 3 is a cross-sectional view of a machined surface of a conventional copper-zinc alloy.

### DETAILED DESCRIPTION OF THE INVENTION

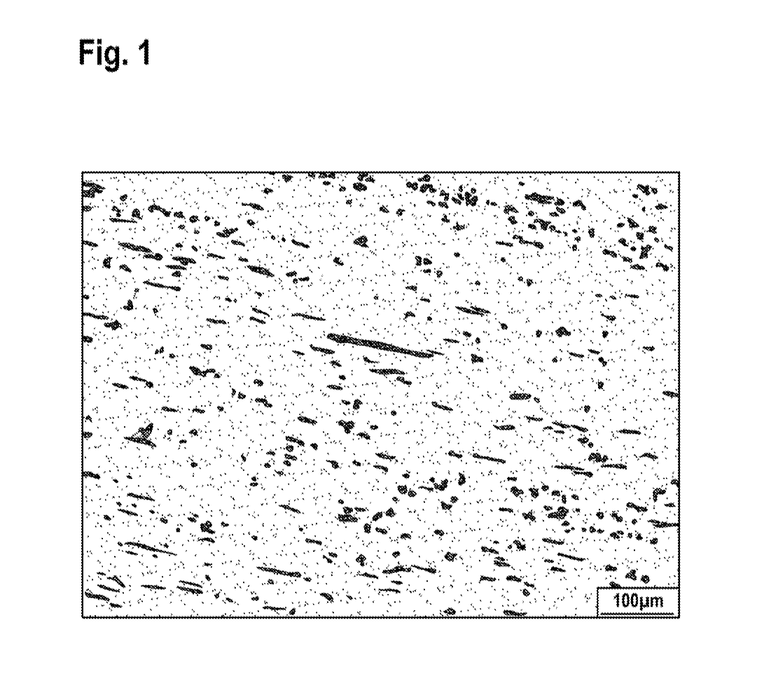

Referring now to the figures of the drawings in detail and first, particularly to FIG. 1 thereof, there is shown a microstructure image of a copper-zinc alloy according to the invention. It is apparent therefrom that a maximum size of the intermetallic compounds (dark crystals) in a longitudinal direction of the crystals is not more than 150 mm.

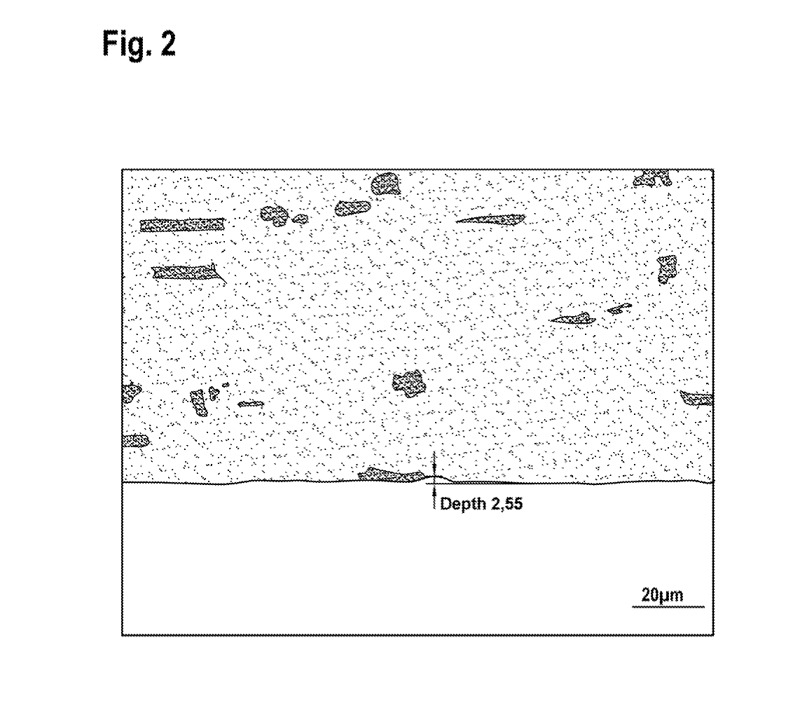

FIG. 2 shows a cross-sectional view through a surface of a component made of the copper-zinc alloy, wherein the surface has been machined. As is apparent from FIG. 2 deviations occur on the surface in the region of intermetallic compounds. The deviations have a maximum depth of about 2.55 μm.

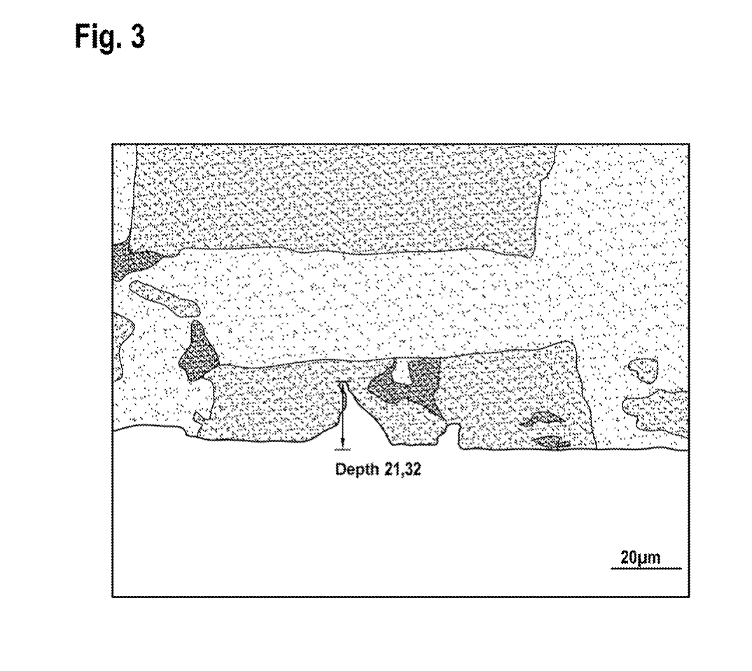

For comparison FIG. 3 shows a cross-sectional view through a machined surface of a component produced from a conventional copper-zinc alloy (70.5% Cu, 7.8% Mn, 5.2% Al, 2.0% Si, 1.0% Fe, balance Zn and avoidable impurities). Deviations having a depth of more than 20 μm occur on the surface here.

With the copper-zinc alloy according to the invention it is thus possible to produce components which, upon machining, exhibit markedly smaller deviations on the surface than components produced from a conventional copper-zinc alloy. With the copper-zinc alloy according to the invention bearing bushings having an improved surface quality, in particular upon machining, can be produced. Owing to its excellent thermal properties the copper-zinc alloy according to the invention is particularly suitable for producing bearing bushings for turbochargers.

1. A copper-zinc alloy, comprising:
59.0 to 65.0% wt. Cu;
2.5 to 4.0% wt. Mn;
1.2 to 2.5% wt. Al;
0.5 to 2.0% wt. Si;
0.2 to 1.0% wt. Fe;
0 to 1.0% wt. Pb;
0 to 1.5% wt. Ni;
0 to 0.2% wt. Sn; and
balance Zn and unavoidable impurities.

2. The copper-zinc alloy according to claim 1, wherein:
62.5 to 64.5% wt. of said Cu;
2.7 to 3.5% wt. of said Mn;
1.3 to 1.9% wt. of said Al;
0.8 to 1.2% wt. of said Si;
0.3 to 0.6% wt. of said Fe;
0 to 1.0% wt. of said Pb;
0 to 1.5% wt. of said Ni;
0 to 0.2% wt. of said Sn; and
balance said Zn and said unavoidable impurities.

3. The copper-zinc alloy according to claim 1, wherein:
63.0 to 64.0% wt. of said Cu;
2.9 to 3.2% wt. of said Mn;
1.4 to 1.9% wt. of said Al;
0.8 to 1.2% wt. of said Si;
0.3 to 0.6% wt. of said Fe;
0 to 1.0% wt. of said Pb;
0.5 to 0.7% wt. of said Ni;
0 to 0.2% wt. of said Sn; and
balance said Zn and said unavoidable impurities.

4. The copper-zinc alloy according to claim 1, wherein the copper-zinc alloy has an electrical conductivity of more than 9.0 m/ohm mm².

5. The copper-zinc alloy according to claim 1, wherein cast state intermetallic compounds present in a microstructure have a size of not more than 150 μm.

6. A bearing bushing, comprising:
a bearing bushing body, containing:
59.0 to 65.0% wt. Cu;
2.5 to 4.0% wt. Mn;
1.2 to 2.5% wt. Al;
0.5 to 2.0% wt. Si;
0.2 to 1.0% wt. Fe;
0 to 1.0% wt. Pb;
0 to 1.5% wt. Ni;
0 to 0.2% wt. Sn; and
balance Zn and unavoidable impurities.

7. The bearing bush according to claim 6, wherein the bearing bushing is a turbocharger bearing bushing.
